(19) United States
(12) Patent Application Publication
(10) Pub. No.: US 2016/0132139 A1
(43) Pub. Date: May 12, 2016

(54) System and Methods for Controlling a Cursor Based on Finger Pressure and Direction

(71) Applicant: QUALCOMM Incorporated, San Diego, CA (US)

(72) Inventors: Junchen Du, San Diego, CA (US); Bo Zhou, San Diego, CA (US); Ning Bi, San Diego, CA (US); Joon Mo Koh, San Diego, CA (US); Jun Hyung Kwon, San Diego, CA (US); Homayoun Dowlat, San Diego, CA (US); Suhail Jalil, Poway, CA (US)

(21) Appl. No.: 14/937,306

(22) Filed: Nov. 10, 2015

Related U.S. Application Data
(60) Provisional application No. 62/078,356, filed on Nov. 11, 2014.

(51) Int. Cl. G06F 3/0354; G06F 3/041

(52) U.S. Cl. CPC G06F 3/03547; G06F 3/0414

(57) ABSTRACT

Disclosed is a method and apparatus for implementing a virtual mouse. In one embodiment, the functions implemented include activating the virtual mouse, determining a location of a cursor icon associated with the virtual mouse, and deactivating the virtual mouse. In various embodiments, the position of virtual mouse is determined by a processor based upon an orientation or position of a finger touching a touchscreen and a measured or calculated pressure applied by the finger to the touchscreen.

### RELATED APPLICATIONS

This application claims the benefit of priority to U.S. Provisional Application No. 62/078,356 entitled “Virtual Mouse Based on Improve Touch Shape Feature” filed Nov. 11, 2014, the entire contents of which are hereby incorporated by reference.

### FIELD

The present disclosure relates generally to electronic devices. Various embodiments are related to methods for operating a Graphical User Interface (GUI) on an electronic device.

### BACKGROUND

Holding a smartphone device in one hand and interacting with the Graphical User Interface (GUI) displayed on the touchscreen display of the smartphone device with only the thumb of the hand holding the smartphone device may be a preferable mode of using the smartphone device under many circumstances. However, as the size of touchscreen display of the smartphone device increases, such single-hand use may become cumbersome or even impossible for at least the reason that given the limited hand size, reaching every corner, especially the top region of the touchscreen display with the thumb of the hand holding the device, may become a challenge.

### SUMMARY

Systems, methods, and devices of various embodiments may enable a computing device configured with a touchscreen to implement a virtual mouse on the touchscreen by activating the virtual mouse during single-handed use of the computing device by a user, determining a position of the virtual mouse on the touchscreen, and projecting a cursor icon onto the touchscreen using the calculated vector. In some embodiments, the projected cursor icon may be positioned to extend beyond a reach of a user's thumb or finger during single-handed use. In some embodiments, determining a position of the virtual mouse on the touchscreen may include identifying a touch area associated with a user touch event, collecting touch data from the identified touch area, determining pressure and direction parameters associated with the user touch event, and calculating a vector representing the position of the virtual mouse based on the pressure and direction parameters associated with the user touch event.

In some embodiments, activating the virtual mouse may include detecting a touch event in a predetermined virtual mouse activation area of a touchscreen display of the computing device. Some embodiments may further include determining, while the virtual mouse is activated, whether a touch event is detected in the predetermined virtual mouse activation area, and deactivating the virtual mouse in response to determining that a touch event has been detected in the predetermined virtual mouse activation area while the virtual mouse is activated.

In some embodiments, activating the virtual mouse may include automatically initiating activation upon detecting that the computing device is held in a manner consistent with single-handed use by the user. In some embodiments, determining the direction associated with the user touch event may be based at least in part on an orientation of a major axis of an ellipse fitted to the touch area. In some embodiments, determining the pressure parameter associated with the user touch event may be based on at least one of an area of the ellipse fitted to the touch area, and a touch pressure, and calculating the position of the virtual mouse may include calculating a vector representing the position of the virtual mouse in which a magnitude of the calculated vector may be based at least in part on the determined pressure parameter.

Some embodiments may further include determining whether the user touch event has ended while the projected cursor icon is positioned over a Graphical User Interface (GUI) element displayed on the touchscreen, and executing an operation associated with the GUI element in response to determining that the user touch event has ended while the projected cursor icon is positioned over the displayed GUI element. Some embodiments may further include automatically deactivating the virtual mouse after the execution of the operation associated with the GUI element.

Some embodiments may further include detecting whether the projected cursor icon is positioned within a threshold distance from an operable Graphical User Interface (GUI) element displayed on the touchscreen, and drawing the projected cursor icon to the operable GUI element in response to detecting that the projected cursor icon is positioned within the threshold distance. Some embodiments may further include detecting whether the projected cursor icon has moved more than a predetermined non-zero distance away from a currently-selected operable Graphical User Interface (GUI) element, and deselecting the operable GUI element in response to detecting that the cursor has moved more than the predetermined non-zero distance from the currently-selected operable GUI element.

Various embodiments include computing device configured with a touchscreen, and including a processor configured with processor-executable instructions to perform operations of the methods described above. Various embodiments also include a non-transitory processor-readable medium on which is stored processor-executable instructions configured to cause a processor of a computing device to perform operations of the methods described above. Various embodiments include a computing device having means for performing functions of the methods described above.

### BRIEF DESCRIPTION OF THE DRAWINGS

The accompanying drawings, which are incorporated herein and constitute part of this specification, illustrate exemplary embodiments, and together with the general description given above and the detailed description given below, serve to explain the features of the claims.

FIG. 1A is a block diagram illustrating a smartphone device suitable for use with various embodiments.

FIG. 1B is a block diagram illustrating an example system for implementing a virtual mouse system on a device according to various embodiments.

FIG. 2 is an illustration of conventional single-handed use of a smartphone device according to various embodiments.

FIG. 3A is a schematic diagram illustrating example touch parameters used to calculate cursor movement according to various embodiments.

FIGS. 3B and 3C are illustrations of an example smartphone device showing calculations used to determine a virtual mouse location according to various embodiments.

FIGS. 4A-4C are illustrations of an example smartphone device touchscreen display showing use of an example virtual mouse interface according to various embodiments.

FIG. 5 is a process flow diagram illustrating an example method for implementing a virtual mouse according to various embodiments.

FIGS. 6A and 6B are process flow diagrams illustrating an example method for implementing a virtual mouse according to various embodiments.

### DETAILED DESCRIPTION

The various embodiments will be described in detail with reference to the accompanying drawings. Wherever possible, the same reference numbers will be used throughout the drawings to refer to the same or like parts. References made to specific examples and implementations are for illustrative purposes, and are not intended to limit the scope of the claims.

The systems, methods, and devices of the various embodiments improve mobile device user experience by providing a virtual mouse pointer for touchscreen-enabled devices. Specifically, in various embodiments, a virtual mouse interface (also referred to as “virtual mouse”) may mitigate the inconvenience of single-handed use of a smartphone due to a mismatch between the size of the display and the user's hand size. The virtual mouse provides a cursor that may be controlled by a single finger (e.g., thumb or other finger). The virtual mouse may interact with GUI elements display in various locations on the touchscreen display. This may include GUI elements that are not easily reachable by a finger or thumb during single-hand use.

In operation, a user may activate the virtual mouse, for example, by tapping a portion of a touchscreen corresponding to a GUI element representing the virtual mouse (e.g., a virtual mouse icon) displayed on the touchscreen. When the virtual mouse is activated, a cursor icon may be displayed by the touchscreen. The displayed cursor icon may indicate the position of the virtual mouse with reference to GUI elements. Properties of a user's finger or thumb on the touchscreen may be calculated by a processor of the smartphone. A processor using signals received from the touchscreen may calculate the touch pressure and orientation of the user's finger (where orientation refers to the angular placement of the user's finger). The position of the virtual mouse may be determined based at least in part on the calculated touch pressure and orientation of the user's finger. In some embodiments, the position of the virtual mouse may be calculated as a vector extending from a center point of the portion of the touchscreen touched by the finger to a distal position on the touchscreen. The vector may have a length or magnitude calculated based on the calculated touch pressure. The vector may have an angular orientation based on the calculated orientation of the finger. The cursor icon may be positioned on the touchscreen display at the distal end of the calculated vector. When the virtual mouse is near a GUI element that is selectable, the cursor icon may be drawn to the GUI element (e.g., an icon), which may be simultaneously enlarged and/or highlighted within the GUI displayed on the touchscreen. The GUI element may be selected by physically lifting the finger off the touchscreen (i.e., away from the smartphone). Lifting the finger from the touchscreen when the cursor is on the object may prompt the processor of the smartphone to launch an associated application or other action. The user may also deactivate the virtual mouse by moving the finger back to the virtual mouse icon (i.e., returning to the portion of a touchscreen corresponding to the GUI element representing the virtual mouse).

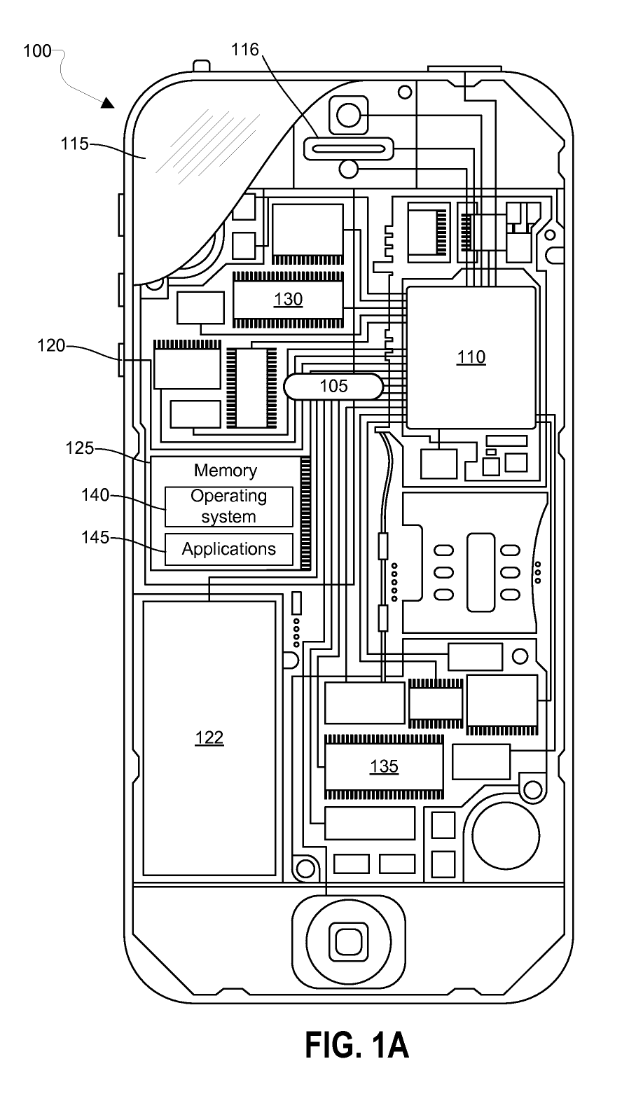

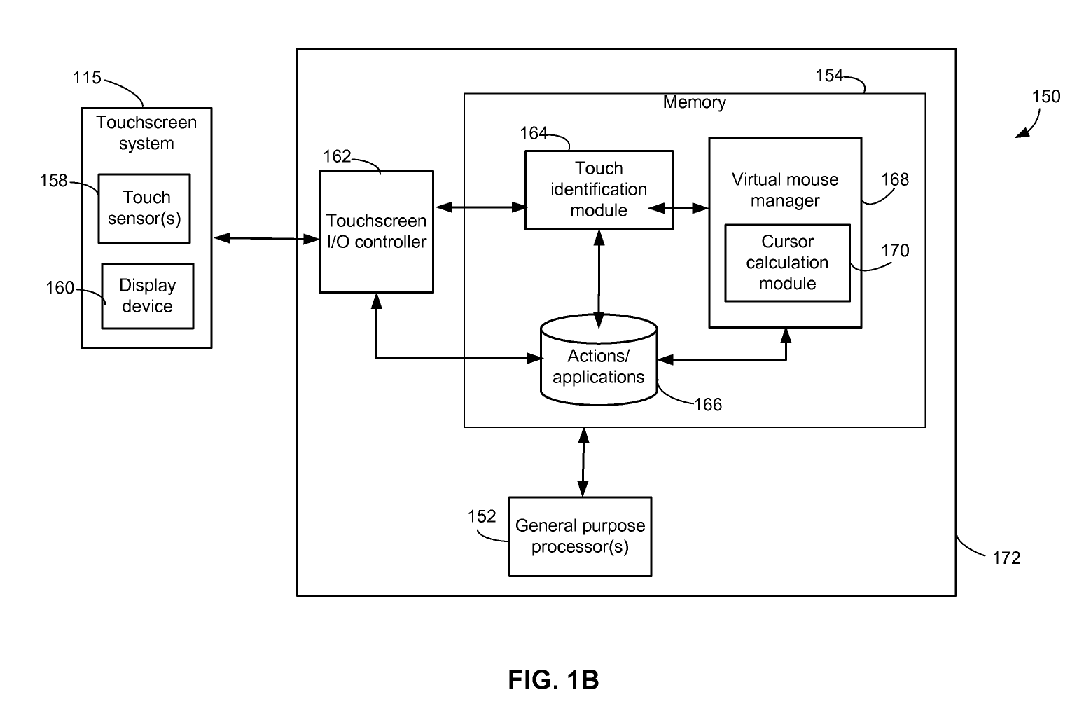

As used herein, the terms “smartphone device,” “smartphone,” and “mobile computing device” refer to any of a variety of mobile computing devices of a size in which single handed operation is possible, such as cellular telephones, tablet computers, personal data assistants (PDAs), wearable device (e.g., watch, head mounted display, virtual reality glasses, etc.), palm-top computers, notebook computers, laptop computers, wireless electronic mail receivers and cellular telephone receivers, multimedia Internet enabled cellular telephones, multimedia enabled smartphones (e.g., Android® and Apple iPhone®), and similar electronic devices that include a programmable processor, memory, and a touchscreen display/user interface. FIG. 1A is a component diagram of a mobile computing device that may be adapted for a virtual mouse. Smartphones are particularly suitable for implementing the various embodiments, and therefore are used as examples in the figures and the descriptions of various embodiments. However, the claims are not intended to be limited to smartphones unless explicitly recited and encompass any mobile computing device of a size suitable for single handed use.

Smartphone device 100 is shown comprising hardware elements that can be electrically coupled via a bus 105 (or may otherwise be in communication, as appropriate). The hardware elements may include one or more processor(s) 110, including without limitation one or more general-purpose processors and/or one or more special-purpose processors (such as digital signal processing chips, graphics acceleration processors, and/or the like), one or more input devices, which include a touchscreen 115, and further include without limitation a mouse, a keyboard, keypad, camera, microphone and/or the like; and one or more output devices 120, which include without limitation an interface 120 (e.g., a universal serial bus (USB)) for coupling to external output devices, a display device, a speaker 116, a printer, and/or the like.

The smartphone device 100 may further include (and/or be in communication with) one or more non-transitory storage devices 125, which can include, without limitation, local and/or network accessible storage, and/or can include, without limitation, a disk drive, a drive array, an optical storage device, solid-state storage device such as a random access memory (“RAM”) and/or a read-only memory (“ROM”), which can be programmable, flash-updateable, and/or the like. Such storage devices may be configured to implement any appropriate data stores, including without limitation, various file systems, database structures, and/or the like.

The smartphone device 100 may also include a communications subsystem 130, which can include without limitation a modem, a network card (wireless or wired), an infrared communication device, a wireless communication device and/or chipset (such as a Bluetooth device, an 802.11 device, a Wi-Fi device, a WiMAX device, cellular communication facilities, etc.), and/or the like. The communications subsystem 130 may permit data to be exchanged with a network, other devices, and/or any other devices described herein. In one embodiment, the device 100 may further include a memory 135, which may include a RAM or ROM device, as described above. The smartphone device 100 may be a mobile device or a non-mobile device, and may have wireless and/or wired connections.

The smartphone device 100 may include a power source 122 coupled to the processor 102, such as a disposable or rechargeable battery. The rechargeable battery may also be coupled to the peripheral device connection port to receive a charging current from a source external to the smartphone device 100.

The smartphone device 100 may also include software elements, shown as being currently located within the working memory 135, including an operating system 140, device drivers, executable libraries, and/or other code, such as one or more application programs 145, which may include or may be designed to implement methods, and/or configure systems, provided by embodiments, as will be described herein. Merely by way of example, one or more procedures described with respect to the method(s) discussed below may be implemented as code and/or instructions executable by the smartphone device 100 (and/or a processor(s) 110 within the smartphone device 100). In an embodiment, such code and/or instructions can be used to configure and/or adapt a general purpose computer (or other device) to perform one or more operations in accordance with the described methods.

A set of these instructions and/or code may be stored on a non-transitory computer-readable storage medium, such as the storage device(s) 125 described above. In some cases, the storage medium may be incorporated within a device, such as the smartphone device 100. In other embodiments, the storage medium might be separate from a device (e.g., a removable medium, such as a compact disc), and/or provided in an installation package, such that the storage medium can be used to program, configure, and/or adapt a general purpose computer with the instructions/code stored thereon. These instructions may take the form of executable code, which is executable by the smartphone device 100 and/or may take the form of source and/or installable code, which, upon compilation and/or installation on the smartphone device 100 (e.g., using any of a variety of generally available compilers, installation programs, compression/decompression utilities, etc.), then takes the form of executable code. Application programs 145 may include one or more applications adapted for a virtual mouse. It should be appreciated that the functionality of the applications may be alternatively implemented in hardware or different levels of software, such as an operating system (OS) 140, a firmware, a computer vision module, etc.

FIG. 1B is a functional block diagram of a smartphone 150 showing elements that may be used for implementing a virtual mouse interface according to various embodiments. According to various embodiments, the smartphone 150 may be similar to the smartphone device 100 described with reference to FIG. 1A. As shown, the smartphone 150 includes at least one controller, such as general purpose processor(s) 152 (e.g., 110), which may be coupled to at least one memory 154 (e.g., 135). The memory 154 may be a non-transitory tangible computer readable storage medium that stores processor-executable instructions. The memory 154 may store the operating system (OS) (140), as well as user application software and executable instructions.

The smartphone 150 may also include a touchscreen 115 (also referred to as a “touchscreen system” and/or “touchscreen display”) that includes one or more touch sensor(s) 158 and a display device 160. The touch sensor(s) 158 may be configured to sense the touch contact caused by the user with a touch-sensitive surface. For example, the touch-sensitive surface may be based on capacitive sensing, optical sensing, resistive sensing, electric field sensing, surface acoustic wave sensing, pressure sensing and/or other technologies. In some embodiments, the touchscreen system 156 may be configured to recognize touches, as well as the position and magnitude of touches on the touch sensitive surface.

The display device 160 may be a light emitting diode (LED) display, a liquid crystal display (LCD) (e.g., active matrix, passive matrix) and the like. Alternatively, the display device 160 may be a monitor such as a monochrome display, color graphics adapter (CGA) display, enhanced graphics adapter (EGA) display, variable-graphics-array (VGA) display, super VGA display, cathode ray tube (CRT), and the like. The display device may also correspond to a plasma display or a display implemented with electronic inks.

In various embodiments, the display device 160 may generally be configured to display a graphical user interface (GUI) that enables interaction between a user of the computer system and the operating system or application running thereon. The GUI may represent programs, files and operational options with graphical images. The graphical images may include windows, fields, dialog boxes, menus, icons, buttons, cursors, scroll bars, etc. Such images may be arranged in predefined layouts, or may be created dynamically to serve the specific actions being taken by a user. During operation, the user may select and activate various graphical images in order to initiate functions and tasks associated therewith. By way of example, a user may select a button that opens, closes, minimizes, or maximizes a window, or an icon that launches a particular program.

The touchscreen system in the various embodiments may be coupled to a touchscreen input/output (I/O) controller 162 that enables input of information from the sensor(s) 158 (e.g., touch events) and output of information to the display device 160 (e.g., GUI presentation). In various embodiments, the touchscreen I/O controller may receive information from the touch sensor(s) 158 based on the user's touch, and may send the information to specific modules configured to be executed by the general purpose processor(s) 152 in order to interpret touch events. In various embodiments, single point touches and multipoint touches may be interpreted. The term “single point touch” as used herein refers to a touch event defined by interaction with a single portion of a single finger (or instrument), although the interaction could occur over time. Examples of single point touch input include a simple touch (e.g., a single tap), touch-and-drag, and double-touch (e.g., a double-tap—two taps in quick succession). A “multi-point touch” may refer to a touch event defined by combinations of different fingers or finger parts.

In various embodiments, the smartphone may include other input/output (I/O) devices that, in combination with or independent of the touchscreen system 156, may be configured to transfer data into the smartphone. For example, the touchscreen I/O controller 162 may be used to perform tracking and to make selections with respect to the GUI on the display device, as well as to issue commands. Such commands may be associated with zooming, panning, scrolling, paging, rotating, sizing, etc. Further, the commands may also be associated with launching a particular program, opening a file or document, viewing a menu, making a selection, executing instructions, logging onto the computer system, loading a user profile associated with a user's preferred arrangement, etc. In some embodiments such commands may involve triggering activation of a virtual mouse manager, discussed in further detail below.

When touch input is received through the touchscreen I/O controller 162, the general purpose processor 152 may implement one or more program modules stored in memory 154 to identify/interpret the touch event and control various components of the smartphone. For example, a touch identification module 164 may identify events that correspond to commands for performing actions in applications 166 stored in the memory 154, modifying GUI elements shown on the display device 160, modifying data stored in memory 154, etc. In some embodiments, the touch identifier module may identify an input as a single point touch event on the touchscreen system 156.

In some embodiments, the touch input may be identified as triggering activation of a virtual mouse, for example, based on the position of a cursor in proximity to a GUI element (e.g., an icon) representing the virtual mouse. Once activated, control of the cursor in the smartphone may be passed to a virtual mouse manager 168. In various embodiments, the virtual mouse manager 168 may be a program module stored in memory 154, which may be executed by one or more controller (e.g., general purpose processor(s) 152).

In various embodiments, a single point touch may initiate cursor tracking and/or selection. During tracking, cursor movement may be controlled by the user moving a single finger on a touch sensitive surface of the touchscreen system 156. When the virtual mouse is not active, such tracking may involve interpreting touch events by the touch identifier module 164, and generating signals for producing corresponding movement of a cursor icon on the display device 160.

While the virtual mouse is active, the virtual mouse manager 168 may interpret touch events and generate signals for producing scaled movement of the cursor icon on the display device 160. In various embodiments, interpreting touch events while the virtual mouse is activated may involve extracting features from the touch data (e.g., number of touches, position and shape of touches, etc.), as well as computing parameters (e.g., touch pressure and/or best fit ellipse to touch area, etc.). In various embodiments, such touch data and computing parameters may be computed by the touchscreen I/O interface 162. Further, a cursor calculation module 170 may use the measured/sensed touch data and computing parameters obtained from the touchscreen I/O interface 162 to determine a cursor location. Other functions, including filtering signals and conversion into different formats, as well as interpreting touch event when the virtual mouse is not activated, may be performed using any of a variety of additional programs/modules stored in memory 154.

In some embodiments, the general purpose processor(s) 152, memory 154, and touchscreen I/O controller 162 may be included in a system-on-chip device 172. The one or more subscriber identity modules (SIMs) and corresponding interface(s) may be external to the system-on-chip device 172, as well as various peripheral devices (e.g., additional input and/or output devices) that may be coupled to components of the system-on-chip device 172, such as interfaces or controllers.

Holding a smartphone device in one hand and interacting with the GUI displayed on the touchscreen display of the smartphone device with only the thumb of the hand holding the smartphone device may be a preferable mode of using the smartphone device under many circumstances. However, as the sizes of the touchscreen displays of smartphone devices increase, such single-hand use may become cumbersome or even impossible. The problems of reaching all portions of the touchscreen display, especially the top region of the touchscreen display, with the thumb or other finger of the hand holding the device may become a challenge, especially for those with small hands.

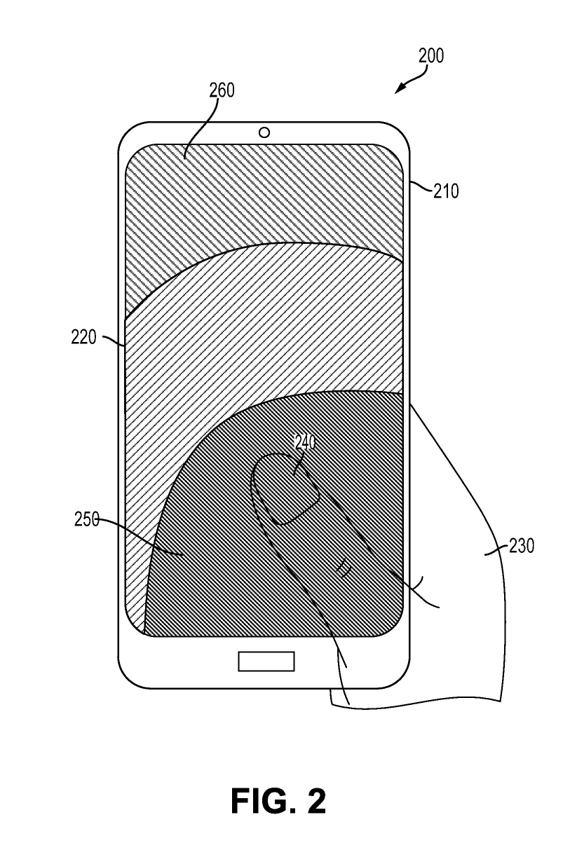

FIG. 2 is an illustration of conventional single-handed use of a smartphone device 200. According to various embodiments, the smartphone device 200 may be similar to the smartphones 100, 150 described with reference to FIGS. 1A-1B. The smartphone device 200 may be configured with a touchscreen display 220 (e.g., display device 160). Holding the smartphone device 200 in one hand 230 and interacting with the GUI displayed on the touchscreen display 220 of the smartphone device with only the thumb 240 (or other finger) of hand 230 may be a preferable mode of using the smartphone device under many circumstances. However, the larger the touchscreen display 220, the more difficult it is to reach every corner with a single finger. The upper region of the touchscreen display 220 may be especially difficult to reach with the thumb 240 (or other finger) of the hand 230 holding the smartphone device. For example, FIG. 2 illustrates a first region 250 of the touchscreen display 220 that is easily reachable by the thumb 240, and a second region 260 of the touchscreen display 220 that is difficult to reach by the thumb 240.

The various embodiments utilize additional inputs made available by processing touch event data generated by the touchscreen to implement a virtual mouse in order to overcome the inconveniences to single-hand use of the smartphone device caused by the mismatch between the size of the touchscreen display and the hand size. The virtual mouse includes a cursor/icon that may interact with different elements of the GUI. The cursor may be movable in the whole region of the touchscreen display by a thumb's corresponding rotation and movement and/or change in pressure on the touchscreen display. With a smartphone device that implements embodiments of the disclosure, the user may interact with elements of the GUI on the touchscreen display that is not easily reachable in the single-handed use scenario using the cursor/icon of the virtual mouse while keeping the thumb within the region of the touchscreen display that is easily reachable.

The virtual mouse may be controlled by any of a number of properties associated with a user's single-point touch. In various embodiments, such properties may be determined using a plurality of mechanisms, depending on the particular configurations, settings, and capabilities of the smartphone. The virtual mouse may be implemented by projecting a cursor icon onto the touchscreen in which the location is calculated based on data from the touchscreen. The location may for example be calculated based on an orientation and pressure of the touch determined from the data. For example, in some embodiments, the smartphone may be configured with a pressure-sensitive touchscreen capable of measuring actual touch pressure. Such pressure-sensitive touchscreen may utilize a combination of capacitive touch and infrared light sensing to determine the touch force. In other embodiments, pressure may be calculated indirectly based on the area of the finger in contact with the touchscreen surface. That is, the relative size of the touch area may serve as a proxy for the touch pressure, where a larger area translates to more pressure. In this manner, instead of actual pressure measurements, the smartphone may calculate an estimated pressure based on the touch area, thereby avoiding a need for additional hardware or sensing circuitry on the device.

The direction of a user's touch may be determined based on the orientation of the major axis of an ellipse that is approximated by the touch area. Alternatively, the direction may be determined based on a line or vector originating from the closest corner of the screen and extending through the touch position.

In some embodiments, the touch direction may be determined based on calculations from the shape of an ellipse approximated by the touch area boundary. Alternatively, the direction may be determined based on the center of the touch area with respect to the closest corner of the touchscreen.

While calculation of the location of the cursor may occur during implementation, various equations referred to in the various embodiments may not be calculated during implementation of the invention, but rather provide models that describe relationships between components of the invention implementation. As discussed above, when the virtual mouse is activated, the properties of input to the touchscreen may be determined by sensing/measuring data of a touch area associated with the user's finger (e.g., thumb) on the touchscreen (i.e., “touch data”). In various embodiments, such touch data may include the location of points forming the boundary of the touch area, and a center of the touch area. In some embodiments, the properties derived from the touch data may include an ellipse function that best fits the boundary of the touch area, and which may be identified using a nonlinear regression analysis. For example, a best fitting ellipse may be defined using Equation 1:

$$( \frac{{x}^{2}}{{a}^{2}} ) + ( \frac{{y}^{2}}{{b}^{2}} ) = 1 \qquad Eq . 1$$

where a represents the semi-major axis and b represents the semi-minor axis of the ellipse, with the semi-major and semi-minor axes aligning on x and y Cartesian axes in which the ellipse center is at the origin point (0,0).

In various embodiments, the major axis of the best fitting ellipse function may be determined by solving for a, where the major axis is equal to 2a. Further, an estimated pressure based on the size of the touch area may be determined by calculating the area of the best fitting ellipse using Equation 2:

Area=π*ab Eq. 2

where a represents the semi-major axis and b represents the semi-minor axis of the ellipse.

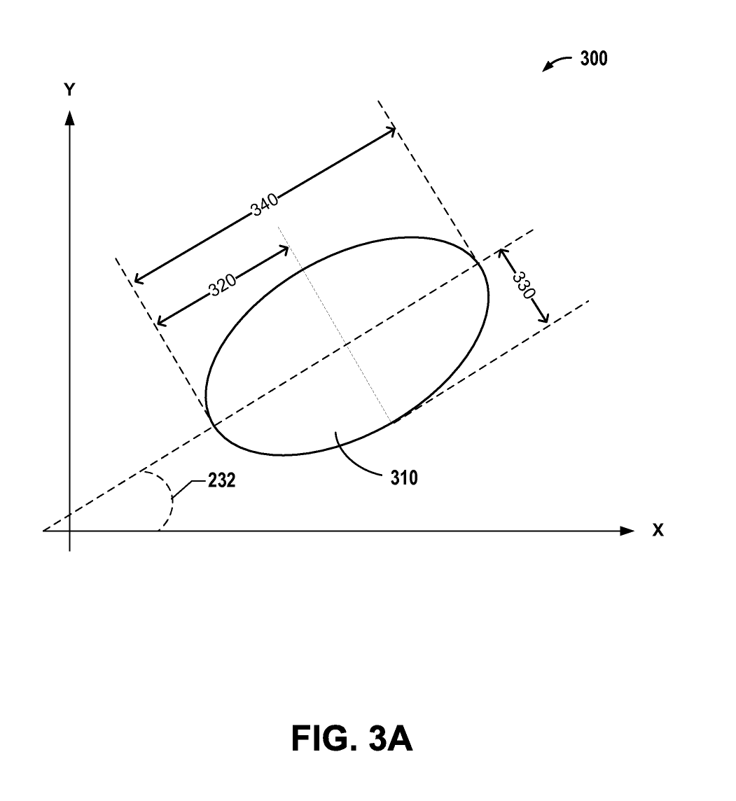

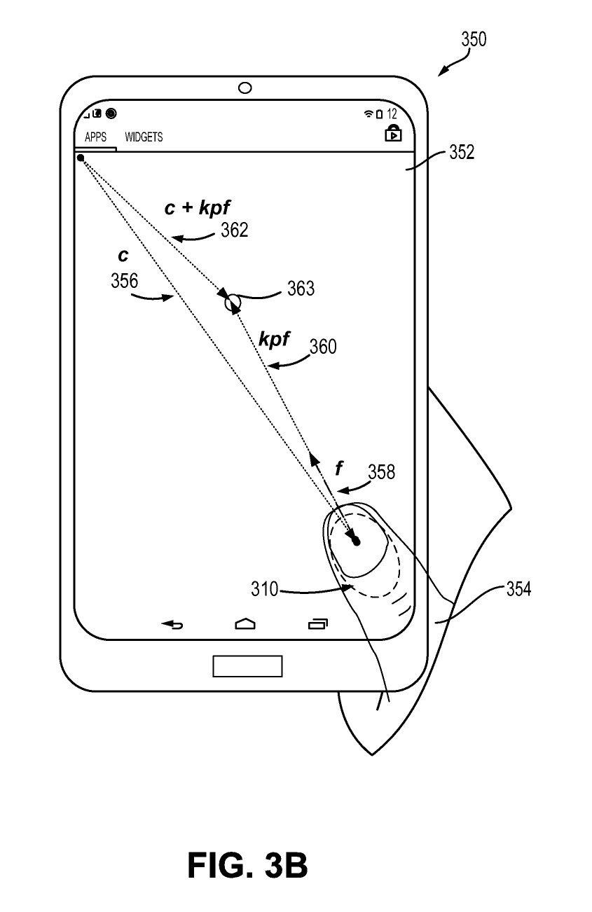

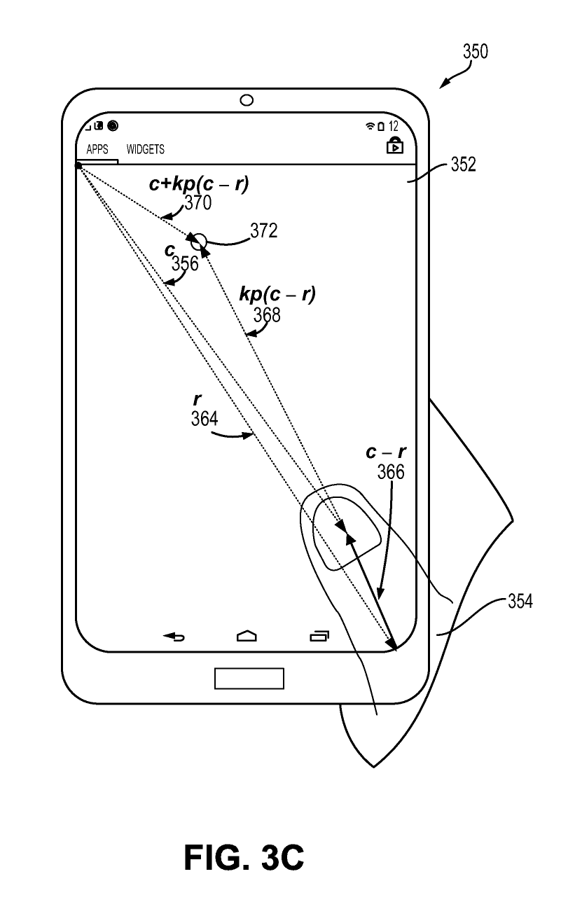

FIG. 3A is a diagram showing an example ellipse function 300 corresponding to a touch area of a user's finger in various embodiments. Conventional touchscreen technologies provide only the positioning (i.e., x, y coordinates) of the touch events. In various embodiments, for each touch event, an orientation of the touch area and a pressure associated with the touch event may be provided in addition to the position of the touch area. The ellipse function 300 is fitted to an approximate touch area 310, and characterized based on a semi-major axis 320 and semi-minor axis 330. In addition to the position of the touch area 310, an orientation of the touch area 310 may be determined as an angle 312 between the positive x-axis and a line segment corresponding to the major axis 340 of the touch area 310. Utilizing the orientation of the major axis to establish touch direction and assuming that the user holds the smartphone device from the edge located closest to the bottom of the touchscreen, the cursor icon may be positioned along a line that is projected out toward the point on the major ellipse that is closest to the top of the touchscreen. Therefore, as shown with respect to the touch area 310, using the left hand may provide an angle 312 that is between 0 degrees (i.e., finger completely horizontal) and 90 degrees (i.e., finger completely vertical). In embodiments using the right hand (not shown), the angle 312 may be between 90 degrees (i.e., finger completely vertical) and 180 degrees (i.e., finger completely horizontal).

Furthermore, a pressure associated with the touch event may also be provided. In some embodiments, the size of the touch area 310 may be used as to estimate pressure because the touch area expands as the touch pressure increases when the touch event is created by an extendable object, such as a finger.

The virtual mouse may be displayed on the touchscreen at a location calculated based on the various touch parameters. In some embodiments, the location of the virtual mouse may be calculated as a vector calculated based on various touch properties. A cursor icon (or other icon) may be displayed to represent the location of the virtual mouse.

In various embodiments, touch properties used to calculate the virtual mouse location may be represented as vectors. For example, the orientation of the major axis of the best fitting ellipse may be represented by a vector f based on a direction pointing toward the top edge of the touchscreen and/or away from the virtual mouse activation area. In another example, the touch position of the user's finger may be represented by a vector c from a starting or reference point to the center point of the touch area. Similarly, the position of the closest corner to the actual touch position may be represented by a vector r from the starting reference point to the closest corner. In various embodiments, the starting or initial reference point of vectors c and r may be the same as the projection point from which the calculated virtual mouse vector is projected out onto the touchscreen—that is, the point at the virtual mouse activation area.

In some embodiments the location of the virtual mouse may be calculated using Equation 3:

Virtual mouse location=c+kpf Eq. 3

where c represents a vector to the center point of the actual touch position (i.e., a position in Cartesian space), f represents a vector corresponding to the orientation of the major axis of an ellipse best fitting the boundary of the touch area, p is a pressure measurement, and k is a scaling factor so that the virtual mouse covers the entire touchscreen.

FIG. 3B illustrates a representative determination of the virtual mouse location on a smartphone device 350 using Equation 3. According to various embodiments, the smartphone device 350 may be similar to the smartphones 100, 150, 200 described with reference to FIGS. 1A-2. The smartphone device 350 may be configured with a touchscreen display 352 (e.g., 160, 220), and a user may interact with the GUI displayed on the touchscreen display 352 with only one finger 354. On the touchscreen display 352, vector 356 provides direction and distance from an initial reference point to the center of the touch area 310 of the finger 354, corresponding to c in Equation 3. While the top left corner of the touchscreen display 352 is used as the initial reference point for the embodiment shown in FIG. 3, the location of the initial reference point is arbitrary, as any of the corners or other points on the touchscreen display 52 may provide the initial reference point. Vector 358 provides a direction representing the orientation of the major axis 340 of an ellipse (e.g., 300) best fitting the boundary of the touch area 310, corresponding to f in Equation 3. In some embodiments, the magnitude of vector 358 may be the actual length of the major axis 340. In other embodiments, the magnitude of vector 358 may be a fixed representative value similar to the scaling factor k.

Vector 360 on the touchscreen display 352 is a resultant vector from multiplying vector 358 by a scalar, and corresponding to kpf in Equation 3. Adding vector 360 to vector 356, a resultant vector 362 provides direction and distance from the initial reference point to the virtual mouse location 363 on the touchscreen display 352. That is, vector 362 corresponds to the calculation in Equation 3 of c+kpf.

In other embodiments, the location of the virtual mouse may be calculated using Equation 4:

Virtual mouse location=c+kp(c−r) Eq. 4

where r represents a vector to the corner of the touchscreen closest to the actual touch location (i.e., a position in Cartesian space).

FIG. 3C illustrates a representative computation of a vector c−r for use in determining the virtual mouse location on the smartphone device 350 using Equation 4. As described with respect to FIG. 3B, vector 356 provides direction and distance from an initial reference point at the top left corner of the touchscreen display 352 to the center of the touch area. Similar to Equation 3, vector 356 corresponds to c in Equation 4. On the touchscreen display 352 in FIG. 3C, vector 364 provides direction and distance from an initial reference point to the corner closest to the actual touch location, corresponding to r in Equation 4. Subtracting vector 364 from vector 356 provides a resultant vector 366, which corresponds to c−r in Equation 4.

Vector 368 on the touchscreen display 352 is a vector resulting from multiplying vector 366 by a scalar and translating its position, corresponding to kp(c−r) in Equation 4. Adding vector 368 to vector 356 results in vector 370, which provides direction and distance from the initial reference point to the virtual mouse location 372 on the touchscreen display 352. That is, vector 372 corresponds to the calculation in Equation 4 of c+kp(c−r).

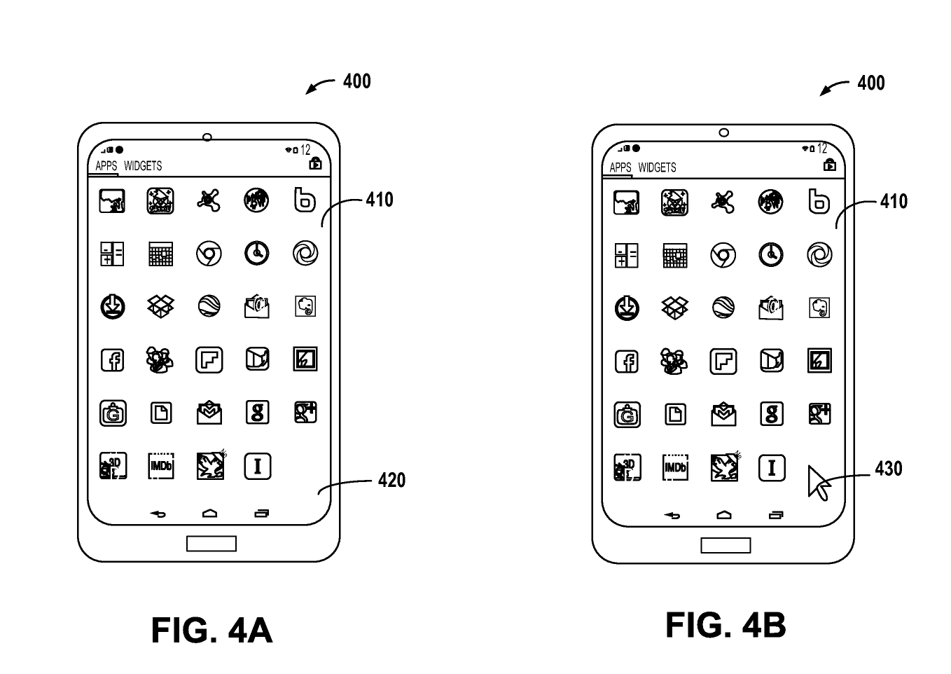

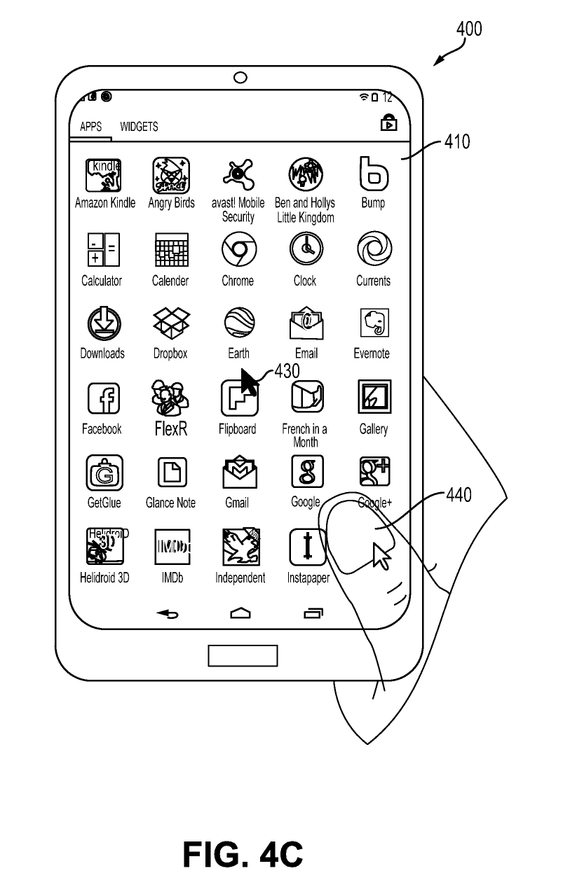

FIGS. 4A and 4B illustrate a smartphone device 400 in which an embodiment of the disclosure is implemented. Smartphone device 400 includes a touchscreen display 410, on which a GUI is displayed. In various embodiments, a predetermined area 420 on the touchscreen display 410 may be designated as the virtual mouse activation area. As will be described in detail below, a user may activate the virtual mouse by touching the activation area 420 with, e.g., a thumb and maintaining the touch (e.g., by not removing the thumb). In FIGS. 4A and 4B, the virtual mouse activation area 420 is in the bottom right corner of the touchscreen display 410. In some embodiments, the actual placement of the virtual mouse activation area may be user-customizable. For example, a user intending to operate the smartphone device 410 with the right hand may designate the bottom right corner as the virtual mouse activation area, and a user intending to operate the smartphone device 410 with the left had may designate the bottom left corner as the virtual mouse activation area. In some embodiments, a user may additionally or alternatively activate the virtual mouse by applying a sufficient amount of force at any area on the touchscreen display 410. For example, the virtual mouse may be activated in response to detecting a touch input with an amount of pressure that is above a threshold value.

Once the virtual mouse is activated, a cursor icon 430 may be displayed on the touchscreen display 410 to signify the same. The GUI element(s) selected by the virtual mouse are indicated by the location of the cursor icon 430, which, as will be described below, may be controlled by the rotation and movement and/or pressure change of the maintained touch by, e.g., a thumb. In some embodiments, the virtual mouse may be automatically activated when a processor determines that the smartphone device 400 is being held in a hand in a manner that is consistent with single-hand use.

FIG. 4C illustrates a smartphone device 400 in which a virtual mouse is activated. As described above, a user may activate the virtual mouse for example by touching the virtual mouse activation area with a finger 440 (e.g., a thumb) and maintaining the contact between the finger 440 and touchscreen display 410. The user may wish to activate the virtual mouse when the user intends to operate GUI elements on a region of the touchscreen display 410 that is not easily reachable by the finger 440. Once the virtual mouse is activated and a cursor icon 430 is displayed, the user may control the location of the cursor icon 430 by rotating the finger 440 and changing at least one of the position of the finger 440 on the touchscreen display 410 and/or the touch pressure. In some embodiments, the location of the cursor icon 430 (e.g., an end point of a vector from the virtual mouse activation area to the current location of the cursor icon 430) may be determined by evaluating the expression c+kpf from (Equation 3) or c+kp(c−r) (Equation 4). As previously noted, in Equations 3 and 4, c is a vector representing the position of the touch area (e.g., a vector from the virtual mouse activation area or initial reference point to a center of the current touch area). As previously noted, in Equation 4 r is a vector representing the position of the closest corner of the touchscreen (e.g., a vector from the virtual mouse activation area or initial reference point to the corner closest to c). As previously noted, in Equation 3, f is a vector representing the orientation of the touch area (e.g., a unit vector indicating the orientation of the touch area). As previously noted, in Equations 3 and 4, p is the touch pressure, and k is a scaling factor chosen so that the user may move the cursor icon 430 to the farthest corner of the touchscreen display 410 with movements of the thumb 440 that are within the easily reachable region of the touchscreen display 410.

Therefore, in an example embodiment, the position of the current touch area, the orientation of the current touch area, and the current touch pressure are all taken into consideration in the determination of the location of the cursor icon 430. In another embodiment, only the position and the orientation of the current touch area are taken into consideration in the determination of the location of the cursor icon 430 (i.e., p in c+kpf or c+kp(c−r) is made constant). In yet another embodiment, only the orientation of the current touch area and the current touch pressure are taken into consideration in the determination of the location of the cursor icon 430 (i.e., c in c+kpf is made constant). In all embodiments, the user may move the cursor icon 430 to the farthest corner of the touchscreen display 410 while keeping the thumb within the region of the touchscreen display 410 that is easily reachable.

In some embodiments, the scaling factor k that may be utilized in the above virtual mouse location calculations may be calibrated to adjust the amount of change in cursor location per movement of the user's finger. In some embodiments, the user receives constant visual feedback from the touchscreen display in the form of the change in location of the displayed cursor icon. Therefore, the user may adjust the relative force and/or motion being employed by the user to achieve desired results. In some embodiments, upon first powering on, the smartphone may be configured to perform some training with a user in order to detect properties of the user's finger size and pressing activity. In this manner, the scaling factor may be adjusted to accommodate the relative input characteristics of each user.

The smartphone may store each user-customized scaling factor for future use for the user (e.g., within a user profile), and may evolve the user's scaling factor over time as details regarding particular touch patterns are collected. In some embodiments, the manufacturer may specify preset maximum and minimum scaling factors (i.e., a scaling factor range) based on the size of the particular display and the relative size and strength of an average human touch input. While these ranges may be used initially, some embodiments provide for eventual customization of a scaling factor over time based on users, effectively replacing a generalized scaling factor with specifically developed values. Such customizations may also be made available for the sensitivity and/or speed of the virtual mouse movement, which may be changed by applying an exponential function in place of the pressure value (i.e., replacing p with p^{x}, where x may be configurable based on user training and/or customization over time. In some embodiments, the user may manually adjust parameters, such as the scaling factor k, the exponential function applied to the pressure p, and/or the threshold values for selecting and/or deselecting GUI elements, etc., such as via various user input mechanisms.

In some embodiments, once the cursor icon 430 is at the desired location on the GUI, an operation may be performed with respect to the GUI element at the location of the cursor. In some embodiments, the processor may determine that the cursor icon 430 is at the desired location on the GUI based on a decrease in velocity of the virtual mouse or pressure of the user's touch that exceeds a threshold value.

In some embodiments, the operation performed when the cursor icon 430 is at the desired location may be the selection of an icon that causes an application (e.g., a game application) to be launched. In another example, the operation may cause a selection of an item (e.g., selection of text, a menu item selection, etc.). The operation may in some embodiments be performed in response to an additional user input with respect to the cursor icon 430. Such an additional user input may include, for example, a recognized gesture by the finger (e.g., click, double click, swipe, etc.) that is received within a threshold time after the cursor icon 430 is at the desired location on the GUI. In another example, the additional user input may be a gesture (e.g., click, double click, swipe, etc.) received from another of the user's fingers.

In another example, the additional user input that triggers performing an operation may be an increase in touch force (i.e., increase in pressure) applied by the user's finger. For example, different levels of force on the touchscreen display 410 may be recognized for different purposes, including performing an operation through the GUI in response to detecting an input force that is beyond a threshold value. In embodiments in which pressure is used to indicate distance for moving the virtual mouse, touch force may be used to prompt performance of an operation (e.g., launching an application, etc.) provided a differentiator is used to distinguish the virtual mouse movement and the operation. For example, a brief pause in touch pressure may be used as a differentiator. In another example, maintaining the cursor icon 430 in one location for a threshold amount of time may differentiate touch pressure for performing an operation from pressure used to calculate the cursor icon 430 location.

In some embodiments, a user may configure one or more additional gestures that trigger the operation through settings on the smartphone device 400. In another example, the operation may be performed in response to detecting termination of the movement of the cursor icon 430 (e.g., indicated by the user removing the thumb from the touchscreen display 410).

In various embodiments, the processor may distinguish between the sudden decrease in touch pressure caused by the ending of the touch, which indicates that the user intends to execute a GUI operation, and the gradual change in touch pressure caused by the user intentionally changing the touch pressure in order to move the cursor icon 430, where appropriate.

In some embodiments, the processor of the smartphone may be configured such that when the cursor icon 430 is moved near an operable GUI element (i.e., within a threshold distance), such as an icon for launching an application or other item (e.g., text, menu item), the cursor icon 430 may be automatically “drawn” to the operable GUI element. The operable GUI element may be enlarged and/or highlighted by the processor once the cursor icon 430 is over it to signify selection. In some further embodiments, an already-selected operable GUI element (i.e., an operable GUI element over which the cursor icon 430 is located) may be deselected only after the cursor icon 430 has been moved away from the GUI element by a predetermined non-zero distance, in order to compensate for jittering in the touch.

In some embodiments, the virtual mouse may be deactivated based on receiving additional user input via the GUI. For example, in an embodiment the user may deactivate the virtual mouse by moving the finger to an area (e.g., the activation area 420) on the GUI, and removing the finger from the touchscreen display 410. In another embodiment, the virtual mouse may be deactivated in response to the user removing the finger from the touchscreen display 410 while the cursor icon 430 is in an area on the GUI that is not within a threshold distance from any operable GUI element.

In some embodiments, the virtual mouse may be automatically deactivated after performing an operation (e.g., selection of an application or item). In other embodiments, the user may deactivate the virtual mouse by performing a particular recognized gesture on the touchscreen display 410. For example, the processor may be configured to deactivate the virtual mouse in response to a double click, a swipe left, a swipe right, a combination thereof, etc. on the touchscreen display 410. In some embodiments, a user may preset one or more particular gestures to trigger deactivation of the virtual mouse.

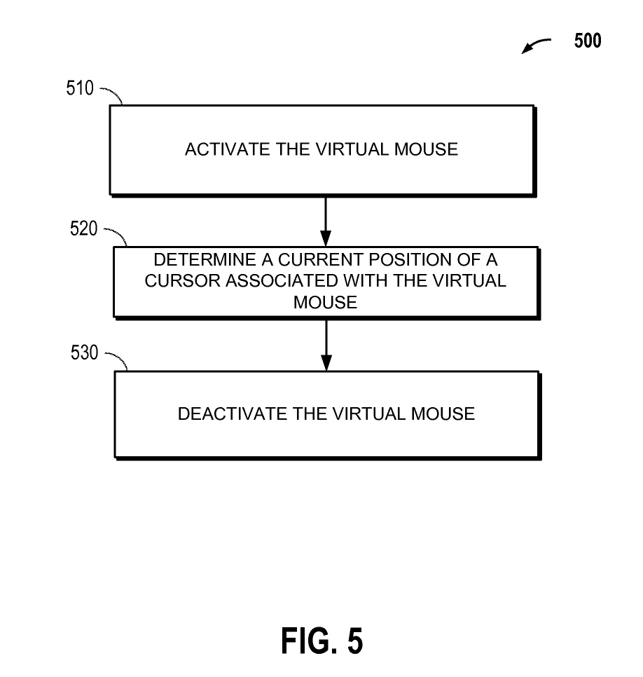

FIG. 5 illustrates a method 500 for implementing a virtual mouse on a smartphone according to some embodiments. The operations of method 500 may be implemented by one or more processors of the smartphone device (e.g., 100, 150), such as a general purpose processor (e.g., 152). In various embodiments, the operations of method 500 may be implemented by a separate controller (not shown) that may be coupled to memory (e.g., 154), the touchscreen (e.g., 115), and to the one or more processors (e.g., 110).

In block 510, a virtual mouse may be activated by a processor of the smartphone. In some embodiments, the virtual mouse may be activated by the processor upon detection of a touch event in the virtual mouse activation area on the touchscreen display, coupled with a continued touch contact. In other embodiments, the virtual mouse may be automatically activated by the processor upon detecting that the smartphone device is being held in a hand in a manner consistent with single-hand use. A cursor or icon may be displayed by the processor to signify the activation of the virtual mouse.

In block 520, a location of the cursor or icon associated with the virtual mouse may be calculated or otherwise determined by the processor. In some embodiments, the location of the cursor/icon may be determined by the processor by evaluating the expression c+kpf (Equation 3) or the expression c+kp(c−r) (Equation 4), both of which yield a vector to the location of the cursor/icon (e.g., a vector from an initial reference point to the current location of the cursor icon).

As previously noted, in Equations 3 and 4, c is the position of the touch area (e.g., a vector from an initial reference point to the current touch area), r is the position of the closest corner of the touchscreen (e.g., a vector from the initial reference point to the closest corner to c), f is the orientation vector of the touch area (e.g., a unit vector indicating the orientation of the touch area), p is the touch pressure, and k is a scaling factor chosen so that the user may move the cursor icon 430 to the farthest corner of the touchscreen display 410 with movements of the thumb 440 that are within the easily reachable region of the touchscreen display 410.

Therefore, the location of the cursor icon may be calculated or otherwise determined by the processor based at least in part on an orientation of the touch area and at least one of 1) a position of the touch area and 2) a touch pressure. In some embodiments, the calculated location of the cursor or icon is used to display a cursor or icon on the display. The location of the cursor or icon on the display may be calculated continuously until the virtual mouse is deactivated by the processor in block 530. The virtual mouse may be automatically deactivated by the processor after a GUI operation, such as an application launch, has been executed by the user ending the touch while the cursor icon is over an operable GUI element. The virtual mouse may also be deactivated by the processor upon detecting that the user has requested a deactivation of the virtual mouse. For example, the processor may detect that the user has performed an operation indicating a deactivation of the virtual mouse (e.g. the user has moved his finger back to the virtual mouse activation area on the touchscreen display and/or ended the touch).

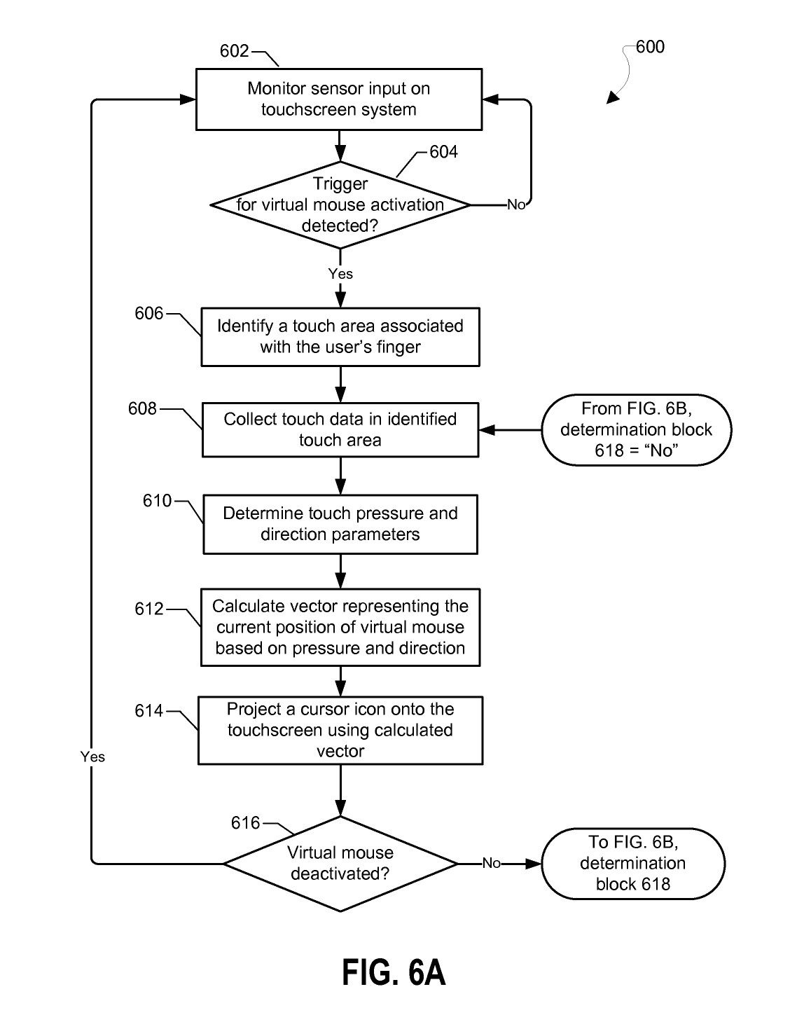

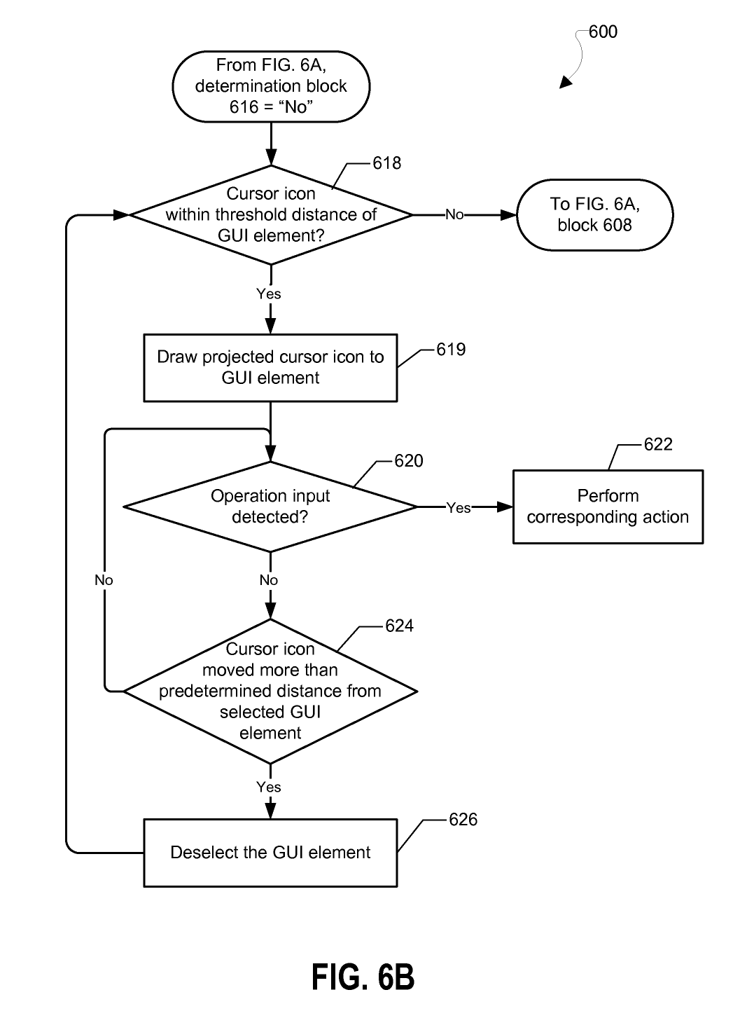

FIGS. 6A and 6B illustrate a method 600 for providing a virtual mouse according to various embodiments. With reference to FIGS. 1-6B, in various embodiments, the operations of method 600 may be implemented by one or more processors (e.g., 110) of a smartphone (e.g., 100, 150), such as a general purpose processor(s) (e.g., 110, 152). In various embodiments, the operations of the method 600 may be implemented by a separate controller (not shown) that may be coupled to memory (e.g., 154), the touchscreen (e.g., 115) and to the one or more processor 152.

In block 602, a processor of the smartphone may monitor touch sensor input on the smartphone (e.g., input to the touch sensor(s) 158, received via the touchscreen I/O controller 162). In determination block 604, the processor may determine whether a trigger activating the virtual mouse is detected. Such trigger may be, for example, input of a single-point touch selecting a virtual mouse icon in the GUI of the display. So long as no trigger of the virtual mouse activation is detected (i.e., determination block 604=“No”), the processor may continue to monitor the touch sensor input on the smartphone in block 602.

In response to determining that a trigger to activate the virtual mouse is detected (i.e., determination block 604=“Yes”), the processor may identify a touch area associated with the user's finger in block 606, which may be the position of the input detected on the touch-sensitive surface through touch sensor(s) (e.g., 158). In block 608, the processor may collect touch data in the identified touch area. For example, data may be sensed/measured by the touchscreen system 156 that includes a size and shape of the touch area, pressure being applied by the user's finger (if using a pressure-sensitive device), etc.

In block 610, the processor may determine touch pressure and direction parameters based on information received from the touchscreen. As discussed above, in some embodiments the touch pressure may be determined as actual pressure if the smartphone is configured with a pressure-sensitive touchscreen. In other embodiments, the touch pressure may be an estimated pressure value based on calculating the area of an ellipse function fitted to the boundary of the touch area. Further, as discussed above, the direction parameter may be based on an orientation of a major axis of such ellipse function, or may be based on the position of the center of the touch area with reference to a closest corner of the touchscreen. In block 612, the processor may calculate a location of the virtual mouse based on the pressure and direction parameters.

In block 614, the processor may display a cursor icon on the touchscreen using the calculated location. In determination block 616, the processor may determine whether the virtual mouse has been deactivated, such as by any of a number of deactivation triggers that may be configured.

In response to determining that the virtual mouse is deactivated (i.e., determination block 616=“Yes”), the processor may return to block 602 and monitor sensor input on the touchscreen system in block 602. In response to determining that the virtual mouse is deactivated, the processor may also terminate displaying the icon displayed in block 614.

In response to determining that the virtual mouse has not been deactivated (i.e., determination block 616=“No”), the processor may determine whether the cursor icon location on the touchscreen is within a threshold distance of a GUI element (i.e., close enough for possible selection) in determination block 618 (FIG. 6B). In response to determining that the cursor icon is not within a threshold distance of a GUI element (i.e., determination block 618=“No”), the processor may repeat the operations in blocks 608-614 (FIG. 6A) to determine the location of the cursor and display the cursor icon.

In response to determining that the cursor icon is within the threshold distance of a GUI element (i.e., determination block 618=“Yes”), the processor may draw the projected cursor icon to the GUI element in block 619. In determination block 620, the processor may determine whether an operation input (e.g., a click, a touch release, a predefined gesture, etc.) is detected, which may be used to initiate an operation relating to that GUI element. In response to determining that an operation input is detected (i.e., determination block 620=“Yes”), the processor may perform an action corresponding to the GUI selection in block 622, for example, opening an application on the smartphone, entering another mode, etc.

In response to determining that an operation input is not detected (i.e., determination block 620=“No”), the processor may determine whether the cursor icon has moved more than a predetermined distance from a selected GUI element in determination block 624. So long as the cursor icon has not moved more than a predetermined distance from a selected GUI element (i.e., determination block 624=“No”), the processor may continue determining whether an operation input is detected in determination block 620.

In response to determining that the cursor icon has moved more than a predetermined distance from a selected GUI element (i.e., determination block 624=“Yes”), the processor may deselect the GUI element in block 626, and return to determination block 618 to determine whether the cursor icon is within a threshold distance of a GUI element.

Utilization of embodiments of the disclosure described herein enables a user to interact with elements of a GUI displayed on a region of a touchscreen display that is difficult to directly reach by effecting touches and movements of a user finger within a region of the touchscreen display that is easily reachable while the user is operating the smartphone device with a single hand. Various embodiments have been described in relation to a smartphone device, but the references to a smartphone are merely to facilitate the descriptions of various embodiments and are not intended to limit the scope of the disclosure or the claims.

Various implementations of a virtual mouse have been previously described in detail. It should be appreciated that the virtual mouse application or system, as previously described, may be implemented as software, firmware, hardware, combinations thereof, etc. In one embodiment, the previous described functions may be implemented by one or more processors (e.g., processor(s) 110) of a smartphone device 100 to achieve the previously desired functions (e.g., the method operations of FIGS. 5 and 6).

The teachings herein may be incorporated into (e.g., implemented within or performed by) a variety of apparatuses (e.g., devices). For example, one or more embodiments taught herein may be incorporated into a general device, a desktop computer, a mobile computer, a mobile device, a phone (e.g., a cellular phone), a personal data assistant, a tablet, a laptop computer, a tablet, an entertainment device (e.g., a music or video device), a headset (e.g., headphones, an earpiece, etc.), a medical device (e.g., a biometric sensor, a heart rate monitor, a pedometer, an electrocardiography “EKG” device, etc.), a user I/O device, a computer, a server, a point-of-sale device, an entertainment device, a set-top box, a wearable device (e.g., watch, head mounted display, virtual reality glasses, etc.), an electronic device within an automobile, or any other suitable device.

In some embodiments, a smartphone device may include an access device (e.g., a Wi-Fi access point) for a communication system. Such an access device may provide, for example, connectivity to another network through transceiver (e.g., a wide area network such as the Internet or a cellular network) via a wired or wireless communication link. Accordingly, the access device may enable another device (e.g., a Wi-Fi station) to access the other network or some other functionality. In addition, it should be appreciated that one or both of the devices may be portable or, in some cases, relatively non-portable.

It should be appreciated that when devices implementing the various embodiments are mobile or smartphone devices that such devices may communicate via one or more wireless communication links through a wireless network that are based on or otherwise support any suitable wireless communication technology. For example, in some embodiments the smartphone device and other devices may associate with a network including a wireless network. In some embodiments the network may include a body area network or a personal area network (e.g., an ultra-wideband network). In some embodiments the network may include a local area network or a wide area network. A smartphone device may support or otherwise use one or more of a variety of wireless communication technologies, protocols, or standards such as, for example, 3G, Long Term Evolution (LTE), LTE Advanced, 4G, Code-Division Multiple Access (CDMA), Time Division Multiple Access (TDMA), Orthogonal Frequency Division Multiplexing (OFDM), Orthogonal Frequency Division Multiple Access (OFDMA), WiMAX, and Wi-Fi. Similarly, a smartphone device may support or otherwise use one or more of a variety of corresponding modulation or multiplexing schemes. A smartphone device may thus include appropriate components (e.g., air interfaces) to establish and communicate via one or more wireless communication links using the above or other wireless communication technologies. For example, a device may include a wireless transceiver with associated transmitter and receiver components (e.g., a transmitter and a receiver) that may include various components (e.g., signal generators and signal processors) that facilitate communication over a wireless medium. As is well known, a smartphone device may therefore wirelessly communicate with other mobile devices, cell phones, other wired and wireless computers, Internet web-sites, etc.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative logical blocks, modules, engines, circuits, and algorithm operations described in connection with the embodiments disclosed herein may be implemented as electronic hardware, computer software, or combinations of both. To clearly illustrate this interchangeability of hardware and software, various illustrative components, blocks, modules, engines, circuits, and operations have been described above generally in terms of their functionality. Whether such functionality is implemented as hardware or software depends upon the specific application and design constraints imposed on the overall system. Skilled artisans may implement the described functionality in varying ways for each application, but such implementation decisions should not be interpreted as causing a departure from the scope of the claims.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in Random Access Memory (RAM), flash memory, Read Only Memory (ROM), Erasable Programmable Read Only Memory (EPROM), Electrically Erasable Programmable Read Only Memory (EEPROM), registers, hard disk, a removable disk, a Compact Disc Read Only Memory (CD-ROM), or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary embodiments, the functions described may be implemented in hardware, software, firmware, or any combination thereof. If implemented in software as a computer program product, the functions or modules may be stored on or transmitted over as one or more instructions or code on a non-transitory computer-readable medium. Computer-readable media can include both computer storage media and communication media including any medium that facilitates transfer of a computer program from one place to another. A storage media may be any available media that can be accessed by a computer. By way of example, and not limitation, such non-transitory computer-readable media can include RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a web site, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of non-transitory computer-readable media.

The previous description of the disclosed embodiments is provided to enable any person skilled in the art to make or use the claims. Various modifications to these embodiments will be readily apparent to those skilled in the art, and the generic principles defined herein may be applied to other embodiments without departing from the scope of the claims. Thus, the present disclosure is not intended to be limited to the embodiments shown herein but is to be accorded the widest scope consistent with the principles and novel features disclosed herein.

What is claimed is:

1. A method implemented in a processor for implementing a virtual mouse on a touchscreen of a computing device, comprising:
activating the virtual mouse during single-handed use of the computing device by a user;
determining a location of the virtual mouse on the touchscreen by:
identifying a touch area associated with a user touch event;
collecting touch data from the identified touch area;
determining pressure and direction parameters associated with the user touch event; and
calculating a position on the touchscreen based on the pressure and direction parameters associated with the user touch event; and
displaying a cursor icon on the touchscreen at the determined location of the virtual mouse.

2. The method of claim 1, wherein the displayed cursor icon is configured to extend beyond a reach of a user's finger during single-handed use.

3. The method of claim 1, wherein activating the virtual mouse comprises detecting a touch event in a predetermined virtual mouse activation area of a touchscreen display of the computing device.

4. The method of claim 1, wherein activating the virtual mouse comprises automatically initiating activation upon detecting that the computing device is held in a manner consistent with single-handed use by the user.

5. The method of claim 3, further comprising:
determining, while the virtual mouse is activated, whether a deactivation event is detected on the computing device; and
deactivating the virtual mouse in response to determining that the deactivation event is detected.

6. The method of claim 5, wherein determining, while the virtual mouse is activated, whether a deactivation event is detected on the computing device comprises determining whether a touch event is detected in the predetermined virtual mouse activation area.

7. The method of claim 1, wherein determining the direction associated with the user touch event is based at least in part on an orientation of a major axis of an ellipse fitted to the touch area.

8. The method of claim 7, wherein:
determining the pressure parameter associated with the user touch event is based on at least one of an area of the ellipse fitted to the touch area, and a touch pressure; and
calculating a location of the virtual mouse comprises calculating a vector representing the location of the virtual mouse, wherein a magnitude of the calculated vector is based at least in part on the determined pressure parameter.

9. The method of claim 8, wherein calculating the vector representing the location of the virtual mouse comprises calculating a resultant vector of an equation:
c+kpf, wherein:
c represents a vector from an initial reference point to a center point of the ellipse fitted to the touch area;
k represents a scaling factor;
p represents the determined pressure parameter; and
f represents a vector corresponding to the orientation of the major axis of the ellipse fitted to the touch area.

10. The method of claim 8, wherein calculating the vector representing the location of the virtual mouse comprises calculating a resultant vector of an equation:
c+kp(c−r), wherein:
c represents a vector from an initial reference point to a center point of the ellipse fitted to the touch area;
r represents a vector from the initial reference point to a corner of the touchscreen display that is closest to the center point of the ellipse;
k represents a scaling factor; and
p represents the determined pressure parameter, and f represents a vector corresponding to the orientation of the major axis of the ellipse fitted to the touch area.

11. The method of claim 1, further comprising:
determining whether a selection input is received while the projected cursor icon is located within a threshold distance of a Graphical User Interface (GUI) element displayed on the touchscreen; and
executing an operation associated with the GUI element in response to determining that the selection input is received while the projected cursor icon is located within a threshold distance of a Graphical User Interface (GUI) element displayed on the touchscreen.

12. The method of claim 11, further comprising automatically deactivating the virtual mouse after execution of the operation associated with the GUI element.

13. The method of claim 1, further comprising:
detecting whether the projected cursor icon is positioned within a threshold distance from an operable Graphical User Interface (GUI) element displayed on the touchscreen; and
drawing the projected cursor icon to the operable GUI element in response to detecting that the cursor icon is positioned within the threshold distance.

14. The method of claim 1, further comprising:
detecting whether the projected cursor icon has moved more than a predetermined non-zero distance away from a currently-selected operable Graphical User Interface (GUI) element; and
deselecting the operable GUI element in response to detecting that the projected cursor icon has moved more than the predetermined non-zero distance from the currently-selected operable GUI element.

15. A computing device, comprising:
a touchscreen;
a memory; and
a processor coupled to the touchscreen and the memory, wherein the processor is configured with processor-executable instructions to perform operations comprising:
activating a virtual mouse during single-handed use of the computing device by a user;
determining a location of the virtual mouse on the touchscreen by:
identifying a touch area associated with a user touch event;
collecting touch data from the identified touch area;
determining pressure and direction parameters associated with the user touch event; and
calculating a position on the touchscreen based on the pressure and direction parameters associated with the user touch event; and
displaying a cursor icon on the touchscreen at the determined location of the virtual mouse,
wherein the projected cursor icon is positioned to extend beyond a reach of a user's thumb or finger during single-handed use.

16. The computing device of claim 15, wherein the processor is configured with processor-executable instructions to perform operations such that the displayed cursor icon is configured to extend beyond a reach of a user's finger during single handed use.

17. The computing device of claim 15, wherein the processor is configured with processor-executable instructions to perform operations such that activating the virtual mouse comprises detecting a touch event in a predetermined virtual mouse activation area of a touchscreen display of the computing device.

18. The computing device of claim 15, wherein the processor is configured with processor-executable instructions such that activating the virtual mouse comprises automatically initiating activation upon detecting that the computing device is held in a manner consistent with single-handed use by the user.

19. The computing device of claim 17, wherein the processor is configured with processor-executable instructions to perform operations further comprising:
determining, while the virtual mouse is activated, whether a deactivation event is detected on the computing device; and
deactivating the virtual mouse in response to determining that the deactivation event is detected.

20. The computing device of claim 19, wherein the processor is configured with processor-executable instructions such that determining, while the virtual mouse is activated, whether a deactivation event is detected comprises determining whether a touch event is detected in the predetermined virtual mouse activation area.

21. The computing device of claim 15, wherein the processor is configured with processor-executable instructions such that determining the direction associated with the user touch event is based at least in part on an orientation of a major axis of an ellipse fitted to the touch area.

22. The computing device of claim 21, wherein the processor is configured with processor-executable instructions such that:
determining the pressure parameter associated with the user touch event is based on at least one of an area of the ellipse fitted to the touch area, and a touch pressure; and
calculating a location of the virtual mouse comprises calculating a vector representing the location of the virtual mouse, wherein a magnitude of the calculated vector is based at least in part on the determined pressure parameter.

23. The computing device of claim 22, wherein the processor is configured with processor-executable instructions such that calculating the vector representing the location of the virtual mouse comprises calculating a resultant vector of an equation:
c+kpf, wherein:
c represents a vector from an initial reference point to a center point of the ellipse fitted to the touch area;
k represents a scaling factor;
p represents the determined pressure parameter; and
f represents a vector corresponding to the orientation of the major axis of the ellipse fitted to the touch area.

24. The computing device of claim 22, wherein the processor is configured with processor-executable instructions such that calculating the vector representing the location of the virtual mouse comprises calculating a resultant vector of an equation:
c+kp(c−r), wherein:
c represents a vector from an initial reference point to a center point of the ellipse fitted to the touch area;
r represents a vector from the initial reference point to a corner of the touchscreen display that is closest to the center point of the ellipse;
k represents a scaling factor; and
p represents the determined pressure parameter, and f represents a vector corresponding to the orientation of the major axis of the ellipse fitted to the touch area.

25. The computing device of claim 15, wherein the processor is configured with processor-executable instructions to perform operations further comprising:
determining whether a selection input is received while the projected cursor icon is located within a threshold distance of a Graphical User Interface (GUI) element displayed on the touchscreen; and
executing an operation associated with the GUI element in response to determining that the selection input is received while the projected cursor icon is located within a threshold distance of a Graphical User Interface (GUI) element displayed on the touchscreen.

26. The computing device of claim 25, wherein the processor is configured with processor-executable instructions to perform operations further comprising automatically deactivating the virtual mouse after execution of the operation associated with the GUI element.

27. The computing device of claim 15, wherein the processor is configured with processor-executable instructions to perform operations further comprising:
detecting whether the projected cursor icon is positioned within a threshold distance from an operable Graphical User Interface (GUI) element displayed on the touchscreen; and
drawing the projected cursor icon to the operable GUI element in response to detecting that the projected cursor icon is positioned within the threshold distance.

28. The computing device of claim 15, wherein the processor is configured with processor-executable instructions to perform operations further comprising:
detecting whether the projected cursor icon has moved more than a predetermined non-zero distance away from a currently-selected operable Graphical User Interface (GUI) element; and
deselecting the operable GUI element in response to detecting that the projected cursor icon has moved more than the predetermined non-zero distance from the currently-selected operable GUI element.

29. A computing device, comprising:
a touchscreen;
means for activating a virtual mouse during single-handed use of the computing device by a user;
means for determining a location of the virtual mouse on the touchscreen comprising:
means for identifying a touch area associated with a user touch event;
means for collecting touch data from the identified touch area;
means for determining pressure and direction parameters associated with the user touch event; and
means for calculating a position on the touchscreen based on the pressure and direction parameters associated with the user touch event; and
means for displaying a cursor icon onto the touchscreen at the determined location of the virtual mouse.

30. A non-transitory processor-readable storage medium having stored thereon processor-executable instructions configured to cause a processor of a computing device to perform operations comprising:
activating a virtual mouse during single-handed use of the computing device by a user;
determining a location of the virtual mouse on a touchscreen by:
identifying a touch area associated with a user touch event;
collecting touch data from the identified touch area;
determining pressure and direction parameters associated with the user touch event; and
calculating a position on the touchscreen based on the pressure and direction parameters associated with the user touch event; and
displaying a cursor icon onto the touchscreen at the determined location of the virtual mouse.
